(19) United States
(12) Patent Application Publication
(10) Pub. No.: US 2022/0385329 A1
(43) Pub. Date: Dec. 1, 2022

(54) FULL-DUPLEX COMMUNICATION METHOD, SYSTEM AND DEVICE

(71) Applicant: Shenzhen Zhongnuoneng Technology Co., Ltd., Shenzhen (CN)

(72) Inventor: Jinsheng LONG, Shenzhen (CN)

(21) Appl. No.: 17/334,785

(22) Filed: May 30, 2021

(51) Int. Cl. H04B 1/44; H04L 5/14; H04L 7/00

(52) U.S. Cl. CPC H04B 1/44; H04L 5/14; H04L 7/0008; G06F 40/205

(57) ABSTRACT

A full-duplex communication device includes an antenna, a transceiving module a conversation module and a control module. The antenna is configured to receive and send signals. Two of the transceiving module are provided, the transceiving module is installed with a filter and a gating switch connecting to the filter, operating frequencies of the two transceiving module are different, and the gating switche is configured to switch operating states between a receiving mode and a sending mode of the transceiving modules. The conversation module is connected to the transceiving modules and configured to receive and play voice signals. The control module is connected to the transceiving modules and configured to control tasks of the transceiving modules.

### BACKGROUND

### 1. Technical Field

The present disclosure relates to a wireless communication field, and more particularly to a full-duplex communication method, system and device.

### 2. Description of Related Art

At present, most radio communication devices, unconnected to the Internet, communicate with each other via half-duplex communication, which is unable to implement full-duplex communication. Under the half-duplex communication, data can be transmitted in both directions of a signal carrier but cannot be transmitted simultaneously. On the other words, the data can only be received and transmitted.

Regarding product realization, a switch button is often set on an off-duplex communication device. As a call is on, the switch button is pressed to send voice data, and is released to receive the voice data, which is impossible to send and receive the voice data at the same time.

The prior art provides some solutions that can implement full-duplex communications, in which two communication devices used respectively serve in a master device and a slave device and require complicated code matching operations.

### BRIEF DESCRIPTION OF DRAWINGS

FIG. 1 is a block diagram of a logic structure of a full-duplex communication device in accordance with an embodiment of the present disclosure; and

FIG. 2 is a block diagram of a brief circuit structure of the full-duplex communication device in accordance with an embodiment of the present disclosure.

### DETAILED DESCRIPTION

To clarify the purpose, technical solutions, and the advantages of the disclosure, embodiments of the invention will now be described more fully hereinafter with reference to the accompanying drawings, in which embodiments of the invention are shown.

As used herein, the term “main control process” refers to a computer-implemented process/method for a physical component. The main control process may be a sub-process, in one example.

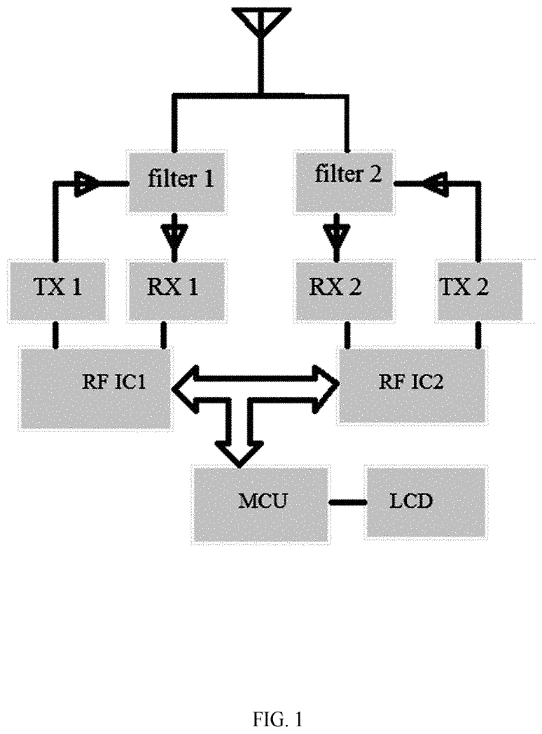

FIG. 1 is a block diagram of a logic structure of a full-duplex communication device in accordance with an embodiment of the present disclosure. The full-duplex communication device includes:

an antenna, configured to receive and send signals;

a first transceiving module and a second transceiving module, wherein the first receiving is installed with a first filter and a first gating switch connecting to the first filter and the second receiving is installed with a second filter and a second gating switch connecting to the second filter, first operating frequency of the first transceiving module is different from second operating frequency of the second transceiving module, and the first and second gating switches are configured to switch operating states between a receiving mode and a sending mode of the first and second transceiving modules;

a conversation module, connected to the first and second transceiving modules and configured to receive and play voice signals; and

a control module, connected to the first and second transceiving modules and configured to control tasks of the first and second transceiving modules.

In this embodiment of the present disclosure, each of the modules can be installed in a case. The case can be a conventional plastic case, a metal case, etc., or can be produce by other new materials. The form and material compositions of the case is not specifically limited in the embodiment of the present invention does not make a specific limitation.

In this embodiment of the present invention, one or more antennas may be provided. The antenna is a conventional element in wireless communication, and its structure and working modes are not described in detail in this embodiment of the present invention. In the embodiment of the present invention, the antenna is connected to a transceiving module, the transceiving module sends information to the outside through the antenna, and the information received by the antenna is transferred to the transceiveing module. In the embodiment of the present invention, optionally, two transceiving modules are set and provided with the same composition, including a filter and a gating switch connected to the filter. In particular, in the embodiment of the present invention, operating frequencies of the filters of the two transceiving modules are different. Under a full-duplex working state, messages received and transmitted by the antenna is isolated from each other by the two filters with different operating frequencies. Therefore, the received messages enters one of the two filter, while the transmitted messages with different frequency that are input from the other filter do not entirely enter the previous filter, which achieving the isolation between the received messages and the transmitted messages. In the embodiment of the present invention, each of the transceiving modules can work in the receiving mode or the sending mode. Whether the transceiving module working in the receiving mode or the sending mode is determined by the state of the gating switch of the transceiving module. The state of the gating switch is controlled by the control module.

In the embodiment of the present invention, a conversation module is also provided, which is used for voice input and output and is a conventional configuration. In the embodiment of the present invention, specific implementations of the conversation module are not specifically limited.

In the embodiment of the present invention, a control module is also included. The control module is used to control tasks of each of the modules. It should be noted that the task controls for each of the modules includes both direct controls and indirect controls. For example, the transceiving module can control tasks of the filter or the antenna via controlling tasks of the transceiving module by the control module, or the control module can directly connect with the antenna or the filter to control their operating states, etc., which are all optional implementations.

The full-duplex communication device provided by the embodiment of the present invention is provided with two transceiving modules. When in use, one of the transceiving modules is used for sending messages and the other transceiving module is used for receiving messages. As a calling is dialed out or received, the transceiving modules used for receiving or sending are different. In addition, each of the transceiving module is provided with a filter, and operating frequencies of the two filters are different. Through the above settings, the full-duplex communication device of the present invention achieves the full-duplex communication, and configurations for a master device and a slave device which are used in communications are not required, which other members of the same group can be called arbitrarily without code matching.

In an embodiment of the present invention, at any time, the operating states of the two transceiving modules are different. In the receiving state and the dialing-out state, the operating states of the same transceiving module are different.

In the embodiment of the present invention, it should be noted that the above-mentioned “any time” refers to any time in the operating state. With regard to non-operating states, the two transceiving modules can simultaneously work in a waiting state instead of a certain operating mode. In the operating state, the states of the two transceiving modules includes: one of the transceiving module works in an operating state while the other transceiving module works in a non-oiperating state, for example, in the early stage of a dialing-out call or the early stage of a receiving call. Specifically, in this embodiment, in regard to a transceiving module works in an initiative dialing-out mode or an initiative receiving mode, the operating states of the two modes of the transceiving module are different.

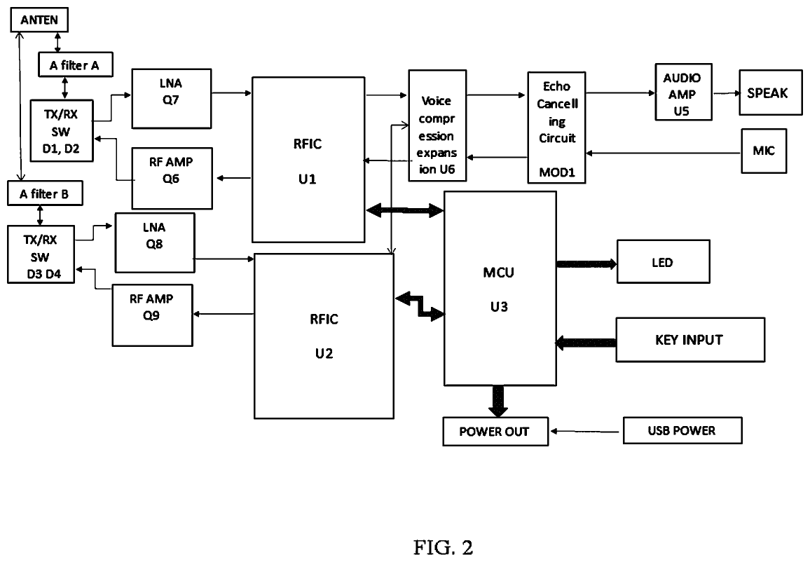

As shown in FIGS. 1 and 2, in an embodiment of the present invention, the gating switch includes a receiving unit and a sending unit. The receiving unit and the sending unit respectively connect to antenna and the control module.

In the embodiment of the present invention, when the transceiving module works in the receiving mode, the receiving unit is turned on while the sending unit is turned off. When the transceiving module works in the sending mode, the receiving unit is turned off while the sending unit is turned on. When the receiving unit or the sending is turned on, the control module can communicate with the antenna, so that the messages can be sent out through the antenna or messages received by the antenna can be transferred to the control module.

In an embodiment of the present invention, operating frequency bands of the filters of the two transceiving modules do not overlap each other.

In the embodiment of the present invention, the filters of the two transceiving modules are respectively configured with an operating frequency band, and the two operating frequency bands of the two filters do not overlap each other. Preferably, the two operating frequency bands can also be separated by a certain distance in the frequency spectrum to achieve limited signal isolation. When the filter is working, the frequency thereof may fluctuate within a certain range. The receiving and sending frequencies can be effectively isolated by setting the operating frequency bands.

As shown in FIGS. 1 and 2, in an embodiment of the present invention, the control module includes a parsing unit and a control unit which are mutually connected each other;

the parsing unit is connected to the transceiving module and is configured to parse signals; and

the control unit is configured to control tasks of the parsing unit.

In an embodiment of the present invention, the conversation unit includes a voice playing unit and a voice receiving unit;

the voice playing unit is configured to play voice signals, an input of the voice playing unit connects to an audio amplifier; and

the voice receiving unit is configured to receive the voice signals.

In the embodiment of the present invention, the voice playing unit may be implemented by a speaker, and the voice receiving unit may be implemented by a microphone.

As shown in FIGS. 1 and 2, in an embodiment of the present invention, a voice compression and expansion unit and an echo cancellation circuit are configured between the conversation unit and the transceiving module.

In an embodiment of the present invention, a low noise amplifier and a radio frequency amplifier are configured between the transceiving module and the control module;

the low noise amplifier is configured between the receiving unit of the transceiving module and the control module; and

the radio frequency amplifier is configured between the receiving unit of the first or second transceiving module.

In an embodiment of the present invention, the full-duplex communication device further includes an auxiliary module, the auxiliary module includes an LED display unit and a button input unit.

In the embodiment of the present invention, the numbers or serial numbers of incoming calls which are displayed through the LED display unit are used to display the numbers or serial numbers of dialing-out calls. The LED display unit can also be used to display information such as power, date, signal strength, etc. The button input unit can set related operating parameters of the device by pressing the keys, and can also start the device, close keys of the device, and dial out by the numbers, etc. In addition, the LED display unit may also include a power interface for connecting to a power source. The power interface may be connected to the power source through a USB cable. As an alternative, a storage battery may be provided in the LED display unit to replace the fixed power source.

The following uses a specific embodiment to illustrate the working process of the full-duplex communication device of the present invention. Among them, the device 1 and the device 2 are two full-duplex communication devices with a calling and called relationship. The process of their internal information transmitted during operation is described as follows:

Receiving process: the receiving part adopts low and medium frequencies.

In the device 1, a RF signal detected by the antenna passes through the TX-RX gating switch composed of D1 and D2 and is amplified by Q7 and is then input to U1 IC (BK4814). In U1, the RF signal is further amplified and mixed into an AF signal. The AF signal is converted to a digital signal through A/D conversion. The digital filtering de-emphasis and other processing are performed to the digital signal, and, therefore, and finally the D/A conversion is performed to the digital signal to convert the digital signal back to the analog AF signal. The generated analog AF signal is pre-amplified internally and output from the 8-th pin of U1. The AF signal sent by U1 is output to the audio power amplifier U5. The amplified AF signal is finally output to the speaker.

In the device 2, a RF signal detected by the antenna passes through the TX-RX gating switch composed of D3 and D4 and is amplified by Q8 and is then input to U2 IC (BK4814). In U2, the RF signal is further amplified and mixed into an AF signal. The AF signal is converted to a digital signal through A/D conversion. The digital filtering de-emphasis and other processing are performed to the digital signal, and, therefore, and finally the D/A conversion is performed to the digital signal to convert the digital signal back to the analog AF signal. The generated analog AF signal is pre-amplified internally and output from the 8-th pin of U2. The AF signal sent by U2 is output to the audio power amplifier U5. The amplified AF signal is finally output to the speaker.

Transmission process: after echo is cancelled, the voice signals acquired by a microphone MIC1 is processed by MOD1, and then processed by U6.

In the device 1, signals are input from the 13-th pin of U2 to U2. In U2, an analog voice signal is further amplified, then is converted into a digital signal via the A/D conversion. The digital filtering, limiting process and other processing are performed to the digital signal. The D/A conversion is finally performed to the digital signal to convert the digital signal to an analog AF signal. The generated analog AF signal is routed to modulate the internal VCO. The modulated RF signal is pre-amplified internally and then output from the 4-th pin of U2. The RF signal from U2 is sequentially amplified by the Q9 power amplifier and output to the antenna.

In the device 2, signals are input from the 13-th pin of U1 to U1. In U1, an analog voice signal is further amplified, then is converted into a digital signal via the A/D conversion. The digital filtering, limiting process and other processing are performed to the digital signal. The D/A conversion is finally performed to the digital signal to convert the digital signal to an analog AF signal. The generated analog AF signal is routed to modulate the internal VCO. The modulated RF signal is pre-amplified internally and then output from the 4-th pin of U2. The RF signal from U2 is sequentially amplified by the Q6 power amplifier and output to the antenna.

It should be noted that the embodiment of the present invention provides a full-duplex communication device. The receiving process and transmission process of the foregoing device 1 and device 2 can be performed at the same time.

An embodiment of the present invention also provides a full-duplex call system, which includes several full-duplex communication devices that can communicate with each other as described in the embodiment of the present invention.

In an operating state, at least two full-duplex communication devices in the full-duplex communication system communicate with each other in a full-duplex communication.

In the embodiment of the present invention, the structural composition of the full-duplex communication device refers to the combination of any one or more of the foregoing embodiments, which will not be repeated in the embodiment of the present invention. The process of the full-duplex call system refers to the call process between the device 1 and the device 2 in the foregoing specific embodiments.

An embodiment of the present invention also provides a full-duplex communication method. The full-duplex communication method includes the following steps:

receiving and transforming voice signals of users;

configuring an operating state of a transceiving module as a sending mode and configuring an operating state of the other transceiving module as a receiving mode;

sending the transformed voice signals via the transceiving module under the sending mode; and

receiving, via the transceiving module under the receiving mode, and transforming radio frequency signals and output the transformed radio frequency signals in a voice form;

wherein the receiving process and the sending process are synchronously performed.

In the embodiments of the present invention, the modules involved in each of the above steps may refer to any one or a combination of the foregoing embodiments. The embodiments of the present invention will not be repeated here.

It should be understood that although the steps in the flowcharts of the embodiments of the present invention are displayed in sequence as indicated by the arrows, these steps are not necessarily executed in sequence in the order indicated by the arrows. Unless there is a clear description in this article, there is no strict order for the execution of these steps, and these steps can be executed in other orders. Moreover, at least part of the steps in each embodiment may include multiple sub-steps or multiple stages. These sub-steps or stages are not necessarily executed at the same time but can be executed at different times. The order of execution is not necessarily carried out sequentially but can be executed alternately or alternately with at least part of other steps or sub-steps or stages of other steps.

A person of ordinary skill in the art can understand that all or part of the processes in the methods of the foregoing embodiments can be implemented by instructing relevant hardware through a computer program. The program can be stored in a non-volatile computer readable storage medium. When the program is executed, it may include the procedures of the above-mentioned method embodiments. Any reference to memory, storage, database or other media used in the various embodiments provided by the present invention may include non-volatile and/or volatile memory. The non-volatile memory may include read only memory (ROM), programmable ROM (PROM), electrically programmable ROM (EPROM), electrically erasable programmable ROM (EEPROM), or flash memory. The volatile memory may include random access memory (RAM) or external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous chain Channel (Synchlink) DRAM (SLDRAM), memory bus (Rambus) direct RAM (RDRAM), direct memory bus dynamic RAM (DRDRAM), and memory bus dynamic RAM (RDRAM), etc.

The technical features of the above-mentioned embodiments can be combined arbitrarily. In order to make the description concise, all possible combinations of the various technical features in the above-mentioned embodiments are not described. However, as long as there is no contradiction in the combination of these technical features, all should be considered as the scope of this specification.

The above description is merely the embodiments in the present disclosure, the claim is not limited to the description thereby. The equivalent structure or changing of the process of the content of the description and the figures, or to implement to other technical field directly or indirectly should be included in the claim.

What is claimed is:

1. A full-duplex communication device, comprising:
an antenna, configured to receive and send signals;
a first transceiving module and a second transceiving module, wherein the first transceiving module is installed with a first filter and a first gating switch connecting to the first filter and the second transceiving module is installed with a second filter and a second gating switch connecting to the second filter, first operating frequency of the first transceiving module is different from second operating frequency of the second transceiving module, and the first and second gating switches are configured to switch operating states between a receiving mode and a sending mode of the first and second transceiving modules;
a conversation module, connected to the first and second transceiving modules and configured to receive and play voice signals; and
a control module, connected to the first and second transceiving modules and configured to control tasks of the first and second transceiving modules.

2. The device according to claim 1, wherein, in any moment, the operating states of the first and second transceiving modules are different, and the operating state of the first or second transceiving module under the receiving mode is different from the operating state of the first or second transceiving modules under the sending mode.

3. The device according to claim 1, wherein the first or second gating switch comprises a first or second receiving unit and a first or second sending unit, the first or second receiving unit and the first or second sending unit connects to the antenna and the first or second transceiving module.

4. The device according to claim 1, wherein a first operating frequency band of the first transceiving module does not overlap a second operating frequency band of the second transceiving module.

5. The device according to claim 1, wherein:
the control module comprises a parsing unit and a control unit which are mutually connected each other;
the parsing unit is connected to the first or second transceiving module and is configured to parse signals; and
the control unit is configured to control tasks of the parsing unit.

6. The device according to claim 5, wherein two of the parsing unit are configured, each of the parsing unit connects to one of the first or second gating switch.

7. The device according to claim 1, wherein:
the conversation unit comprises a voice playing unit and a voice receiving unit;
the voice playing unit is configured to play voice signals, an input of the voice playing unit connects to an audio amplifier; and
the voice receiving unit is configured to receive the voice signals.

8. The device according to claim 1, wherein a voice compression and expansion unit and an echo cancellation circuit are configured between the conversation unit and the first or second transceiving module.

9. The device according to claim 1, wherein:
a low noise amplifier and a radio frequency amplifier are configured between the first or second transceiving module and the control module;
the low noise amplifier is configured between the first or second receiving unit of the first or second transceiving module and the control module; and
the radio frequency amplifier is configured between the first or second receiving unit of the first or second transceiving module.

10. The device according to claim 1, further comprising an auxiliary module, wherein the auxiliary module comprises an LED display unit and a button input unit.

11. A full-duplex communication system, wherein:
the full-duplex communication system comprises a full-duplex communication system according to claim 1 that can communicate with each other; and
in an operating state, at least two full-duplex communication devices in the full-duplex communication system communicate with each other in a full-duplex communication.

12. A full-duplex communication method, comprising:
receiving and transforming voice signals of users;
configuring an operating state of a transceiving module as a sending mode and configuring an operating state of the other transceiving module as a receiving mode;
sending the transformed voice signals via the transceiving module under the sending mode; and
receiving, via the transceiving module under the receiving mode, and transforming radio frequency signals and output the transformed radio frequency signals in a voice form;
wherein the receiving process and the sending process are synchronously performed.
